(19) United States
(12) Patent Application Publication
(10) Pub. No.: US 2017/0231855 A1
(43) Pub. Date: Aug. 17, 2017

(54) PHYSICAL THERAPY AND WALKER APPARATUS

(71) Applicant: KCAZ Enterprises, LLC, Orlando, FL (US)

(72) Inventor: Charles A. Frazier, JR., Holiday, FL (US)

(73) Assignee: KCAZ Enterprises, LLC, Orlando, FL (US)

(21) Appl. No.: 15/164,288

(22) Filed: May 25, 2016

Related U.S. Application Data
(60) Provisional application No. 62/304,182, filed on Mar. 5, 2016.
(60) Provisional application No. 62/294,819, filed on Feb. 12, 2016.

(51) Int. Cl. A61H 3/00; A61H 3/04

(52) U.S. Cl. CPC A61H 3/008; A61H 3/04

(57) ABSTRACT

An apparatus is disclosed comprising an upper frame and a lower frame together connected by at least one lifting means, wherein the lower frame comprises two sidebars connected at opposite ends of a lower crossbar to form a “U” shape, wherein the upper frame comprises two handrails, each having a free end and an attachment end, wherein the attachment end of each handrail is rotatably connected to an upper crossbar, and the lifting means are disposed between the lower crossbar and upper crossbar such that the upper frame experiences a force exerted by the lifting means when the handrails parallel to a plane formed by the lower frame. In another embodiment, the apparatus is a walker having a harness in removable communication with the handrails.

### FIELD OF THE INVENTION

The invention is directed generally to devices for aiding patients in walking, moving, and/or physical therapy.

### CROSS-REFERENCE TO RELATED APPLICATIONS

This application claims priority to provisional patent application No. 62/304,182, fled on or about Mar. 9, 2016 by present inventor, as well as priority to provisional patent application 62/294,819 filed on or about Feb. 12, 2016 by the present inventor.

### BACKGROUND

Standard walkers with four wheels are known in the art. These devices allow a user to support his or her weight using their hands, or in some cases by including a seat, to help provide support for their weight. For instance, U.S. Pat. No. 6,733,018 to Eli Razon is a walker that is intended to assist a user moving from a seated position to a standing position. In this device, the harness is connected to lift arms and the user's hands hold on to separate handles.

### SUMMARY

The inventor has also recognized that an improved device for reducing weight on a user's lower limbs is an apparatus comprising lifting means which can provide a usable, continuous lift throughout the duration of use. The inventor has also recognized that the device of U.S. Pat. No. 6,733,018 to E. Razon could not provide a continuous lift, because if it did, it would effectively pushing and crowding the patient to the very front of Razon's device, lifting them entirely too high, which would defeat the purpose of that device. Therefore, while Razon's device may reduce weight in the limited case where the patient rises (or sits), once the patient has risen from a seated to standing position (or vice versa), the device ceases to provide lift greater than what would be experienced by anyone simply leaning on a surface, table, or other standard walker.

The inventor has recognized that when a patient's arms get tired, they may not be able to support and reduce force on their lower limbs as well, and that the disclosed device would overcome these challenges. In embodiments, the device comprises a lifting means situated between an upper frame and lower frame, wherein the lifting means may be a gas spring in communication with a moment arm. The lifting means joins the upper and lower frame with the moment arm in communication with an upper crossbar of the upper frame, and a lower portion of the gas spring in communication with the lower frame's lower crossbar. In other embodiments, the apparatus comprises an upper frame and a lower frame together connected by at least one lifting means, wherein the lower frame comprises two sidebars connected at opposite ends of a lower crossbar to form a “U” shape, whereas the upper frame comprises two handrails, each having a free end and an attachment end, wherein the attachment end of each handrail is rotatably connected to an upper crossbar. In this embodiment, the lifting means are disposed between the lower crossbar and upper crossbar such that the upper frame experiences a force exerted by the lifting means when the handrails parallel to a plane formed by the lower frame. In other embodiments, the apparatus further comprises a harness in communication with the handrails via a connection such as the handrail caps disclosed below.

Details of the construction of the device are provided in the detailed description, including variations which are included and incorporated into this summary. The mode and means for constructing the disclosed device are described in detail in the Detailed Description. Equivalents and features contemplated below are made part of this Summary.

### BRIEF DESCRIPTION OF THE DRAWINGS

FIG. 1 is a front perspective, environmental view of the apparatus including a harness, in accordance with an embodiment.

FIG. 2 is a rear perspective view of the apparatus, in accordance with an embodiment.

FIG. 3 is a view of the harness of the device, in accordance with an embodiment.

FIG. 4A shows a moment-arm of the device, in accordance with an embodiment.

FIG. 4B shows a moment-arm of the device, in accordance with an embodiment.

FIG. 5 shows a front perspective environmental view, in accordance with an embodiment.

### DETAILED DESCRIPTION

Disclosed is an apparatus which may be used as a walking assistance device for individuals with physical impairments such as cerebral palsy, muscular dystrophy, spinal injuries, stroke victims, or general physical disorders. Advantages include improved means by which a user is prevented from applying their full weight on their hips, legs, knees, or feet while using the device. In embodiments, the device is designed to remove a portion of the user's body weight below the waist, thereby allowing the user to walk without pain or physical injury while at the same time performing physical therapy. In one embodiment, the device is a walker. The device may include a harness in embodiments.

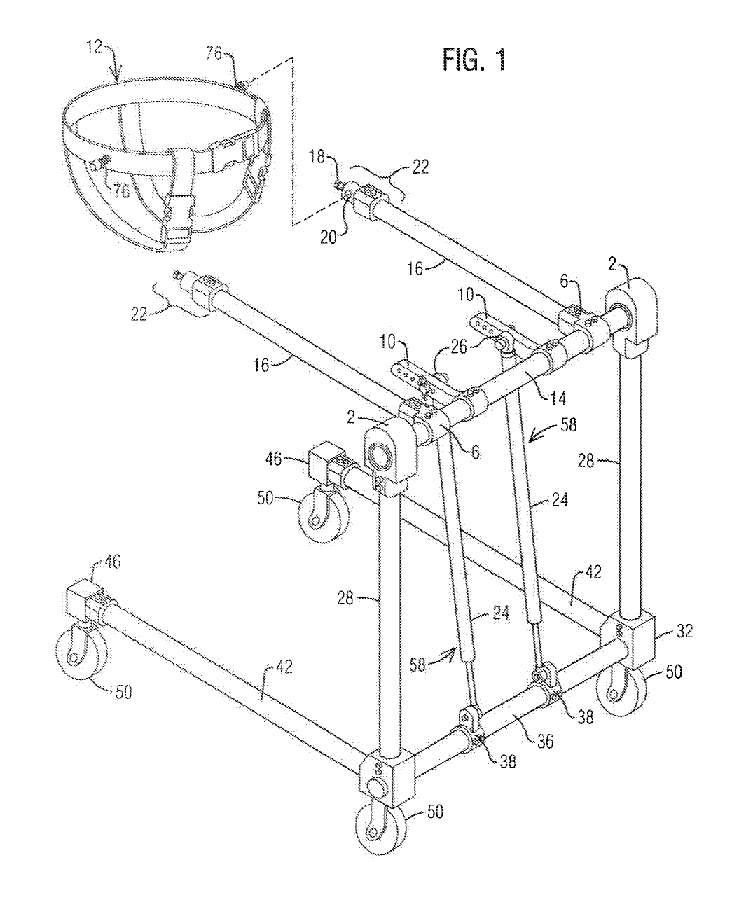

FIG. 1 shows various components of an embodiment. In this embodiment, there is a lower frame and upper frame, together communicating via at least one lifting means 58. The upper frame and lower frame may be further supported by at least one vertical post 28. In the embodiment shown, two vertical posts 28 are connected at one end to the upper frame, and at the other end to the lower frame.

In the embodiment of FIGS. 1, 2, and 5, the lower frame has two sidebars 42, connected at their ends to opposite ends of a lower crossbar 36, as shown. The lower frame may be further supported by four wheels 50, in which case, forward wheel supports 32, and rear wheel supports 46, are included, together connected as shown. In other embodiments, the wheels 50 and wheel supports 32 are not present on the lower frame. The side bars 42 and lower crossbar 36 may be parts of one contiguous, generally “U” shaped piece. These structures themselves may be a solid or hollow bar made of metal or sturdy plastic or other polymer or composite material. Alternatively, the sidebars 42 and lower crossbar 36 may be modular bars connected through joints. In the embodiment pictured, said joints are front wheel supports 32, which serve not only to support and receive a wheel 50, but also to serve as the connecting joint between the sidebar 42 and the lower crossbar 36.

The upper frame is comprised of an upper crossbar 14 in communication with at least one handrail 16 connected at the end of the upper crossbar 14. In the embodiment pictured, the upper crossbar communicates with two handrails 16, at the opposite end of the upper crossbar 14. As with the lower frame, the upper frame's upper crossbar and handrails may be portions of one contiguous one contiguous, generally “U” shaped piece. However, because the handrails are in slidable communication with the crossbar, the shape of the upper frame is not confined to simply a “U” shape. Rather, the two handrails are preferably a rigid longitudinal member, such as a metal or PVC bar, each having a free end and an attachment end, wherein the attachment end of each handrail is rotatably connected to an upper crossbar Alternatively, the upper crossbar and handrails may be separate modular components connected with joints. For example, FIG. 1 shows the upper crossbar 14 (engaging with the vertical posts 28 via corner blocks 2), two handrails 16, two handrail ends 6.

As mentioned previously, the upper frame and the lower frame are connected via a lifting means 58. The lifting means comprise in embodiments a gas spring adapted to communicate with one or more moment-arms 10, said moment-arms 10 themselves in communication with the upper crossbar 14. This lifting means 58 serves as an intervening member between the upper and lower frames. The lifting means may further include the moment arms 10 connected to a gas spring 24 such that the moment arm may rotate about a joint axis defined by the intersection of the moment arm and the upper crossbar 14. The gas springs may comprise a piston head on a rear end of a ram for compressing gas contained within the piston to exert a force. While gas springs are pictured, other compression tension components which provide a lifting force may be employed, such as metal springs.

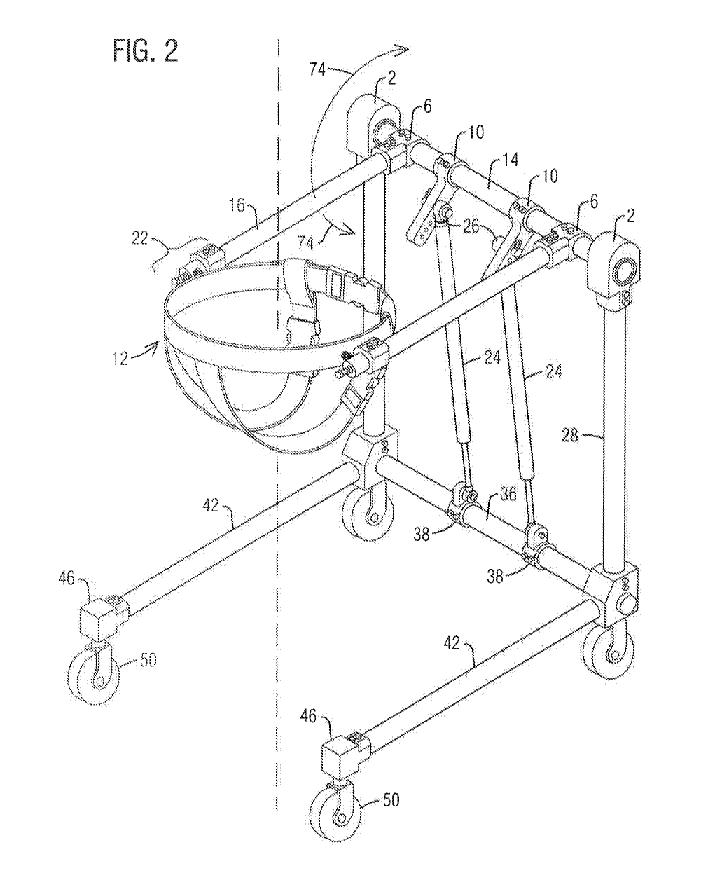

Continuing with the embodiment depicted in the FIGS. 1 and 2, moment arms 10 may be connected at one end to the upper crossbar, as shown, and to the gas springs 24 at the other end. The upper crossbar rotates about its center longitudinal axis within the corner blocks 2 when acted upon the by the upward force supplied by the gas spring 24, and corresponding rotation of the moment arm 10. The embodiment pictured shows two lifting means 58, although one or a plurality may be employed.

The gas springs 24 of FIG. 1 are attached to the lower crossbar 36 via lower ram supports 38. The upper end of the gas springs 24 are attached to the moment-arms 10. This causes the handrails 16 to be forced upward applying a lifting force on the handrail caps 22. Because said moment-arms 10 are mounted between said handrail ends 6, said handrail ends 6 may be moved in or out along the upper crossbar 14 to adjust for the girth of the user.

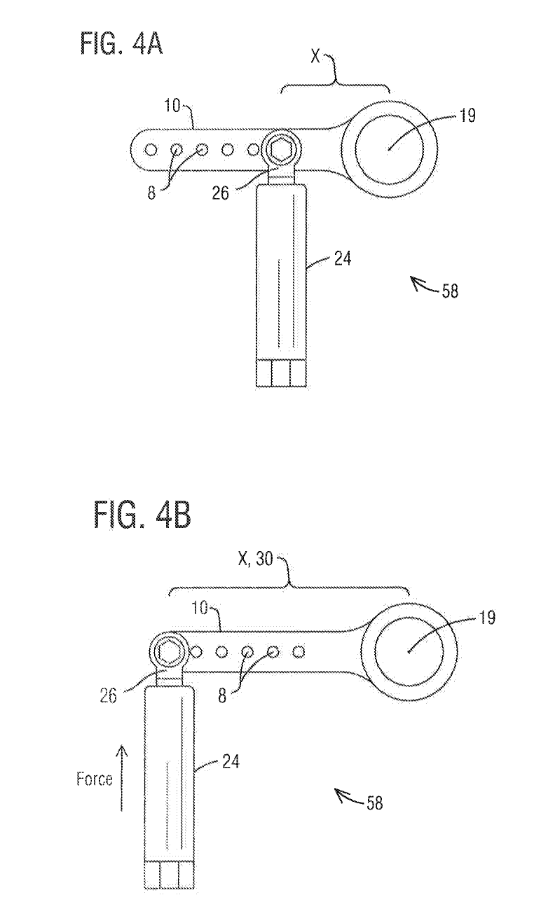

As can be seen in both FIG. 1 and FIG. 2, the upper crossbar 14 is connected to at least one moment-arm 10, which itself engages with gas spring 24. Referring to FIGS. 4A-B, the “moment-arm” 10 refers to the component having a joint axis 19, which is the axis about which the moment arm 10 rotates vis a vis the upper crossbar 14. This preferably rigid piece may be fitted with several openings 8 so that a gas spring 24 may be connected at these openings at various distances x, e.g. 30, from said joint axis 19. The longer the moment-arm is, the more load will be applied to the joint axis through leverage. Referring to FIGS. 4A and 4B, to make the moment-arm longer or shorter, the gas spring 24 may be connected (via connections 26) to the moment-arm 10 at varying locations. The varying of the location of the connection of the gas spring to the moment-arm 10 changes the distance between the connector 26 to the joint axis 18. This allows a user to adjust the upward three applied to the moment-arm 10, which in turn varies the rotational force the moment arm exerts on the upper crossbar. This force is transferred to the handrail ends 6, then the handrail 16, and results in a continuous upward lifting force that can be experienced when a user places weight onto the handrails. FIG. 4A shows said gas spring 24 attached to the first hole in said moment-arm 10 providing the least amount of upward force to the handrails. FIG. 4B shows the gas spring 24 attached to the last hole in the moment-arm 10 which would provide the largest lifting force on the handrails. The lifting force supplied by the device is greater than simply the counteracting normal force applied by a surface when a body exerts a force on that surface.

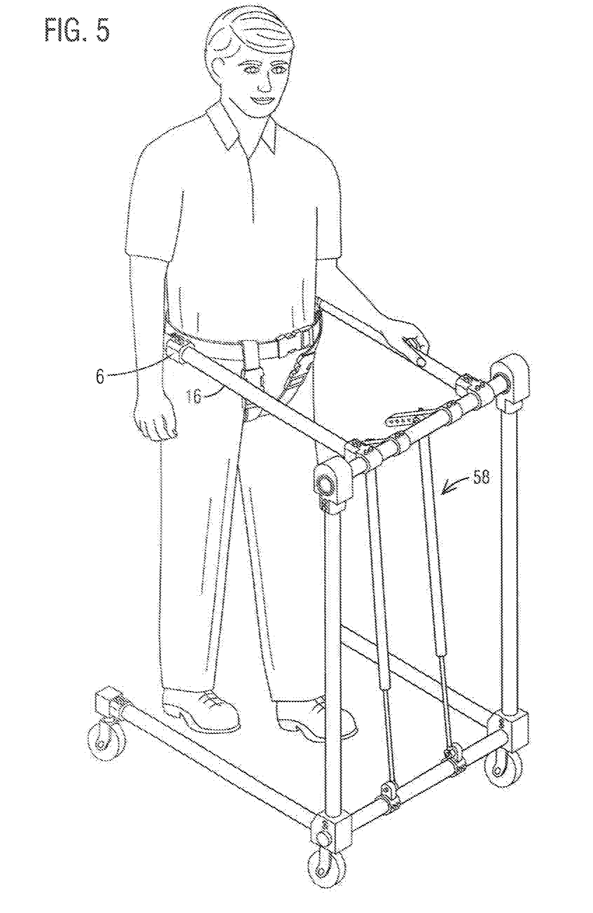

FIG. 2 shows another view of an embodiment. The handrail ends 6 and moment-arms 10 are in rigid communication with the upper crossbar 14. The handrails 16 are rigidly attached to the handrail ends 6 forming a solid unit. The moment-arms 10 are mounted in communication with upper crossbar 14, such that they are positioned in between the handrails 16. This creates a short stroke dual moment-arm to ensure that under normal operation the gas springs 24 do not become fully extended, thereby losing their expanding force. A short upward movement of the moment-arms 10 will cause the upper crossbar 14 to rotate providing a larger upward movement of the handrail 16 and corresponding handrail caps 22. The upward force applied to the handrail caps 22 will impart a lifting force to the harness when attached. For ease of view of the various components, the moment arms 10 are shown in parallel to the handrails 16 in FIG. 1, however, the device is configured in another embodiment to have the moment arms 10 approximately halfway extended when the handrails are parallel to the ground. For example, FIGS. 2 and 5 show a 45 degree angle between the handrails 16 and the moment arms 10 when the hand rails are parallel to the ground.

Arrow 74 shows a range of motion of the handrails, but it is understood that the tension and force supplied by the lifting means can be varied to accommodate users having different weights. A force suitable for an adult male would be too strong for a child, for instance. In use, the lifting force is preferably constant, but gentle so as to provide lift, but not hoist the user off their feet. Reference is made to an environmental view of the device shown in FIG. 5.

Arrows 74 in FIG. 2 shows the potential range of rotation of the handrails wherein the handrails experience a constant lifting force exerted by the lifting means. While a full 90 degrees in either direction (relative to the position pictured) will experience this force, it is recognized that the user holding on to the handrails will cause the handrails only to rotate between 30-45 degrees in either direction when in normal use. This configuration ensures that when the handrails are at a position of normal use, there is a constant upward force exerted upon the handrails by the lift produced by the lifting means.

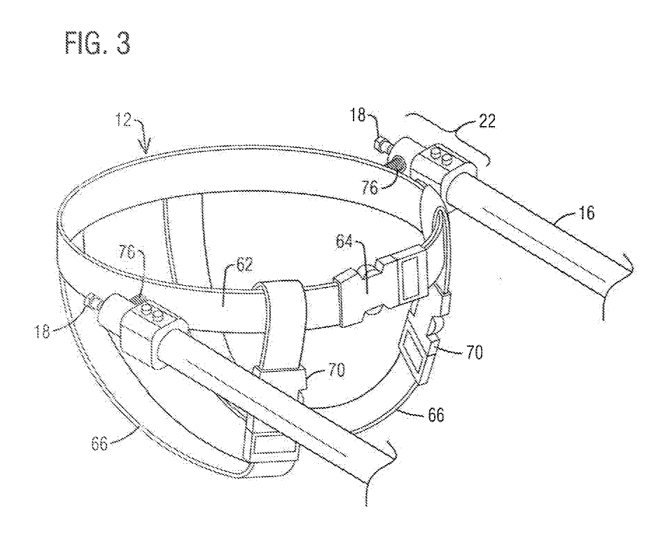

FIG. 5 shows an embodiment in use with a harness 12 and user attached. In this position the gas spring 24 is extended, but not through its maximum range of motion, thereby reducing the weight of the user. Note that because the harness is attached to the handrails (via the handrail caps 22) preferably at the position corresponding to the hips of the user, there is no possibility that a user could be forced or crowded into the front of the device near the upper crossbar as a result of the continuous lifting force. As force is applied in an upward direction by the gas spring 24, against the moment-arm 10 it causes the upper crossbar to rotate clockwise inside the upper corner block 2. As the upper crossbar rotates clockwise, the handrail 16 is forced upward applying a lifting force to the handrail cap 22 that is attached to the harness attachment-pins 18 (FIGS. 1, 3). The upward acting force on the handrail 16 is transferred down through the moment-a 10 and gas spring 24 to the lower ram support 38 and lower crossbar 36. This force is then transferred to the forward wheel supports 34, sidebar 42, rear wheel supports 46, and down to the wheels 50. A user in the device as shown in FIG. 5 would therefore experience a reduction in his or her weight, yet remain comfortably positioned just behind the upper and lower frames.

FIG. 3 shows a close up view of an embodiment of the harness 12. A harness belt 62 which is configured to encircle the user's waist and is secured with the main buckle 64. The two leg straps 66 are passed between the legs and attached to the two respective leg strap buckles 70 and then tightened by pulling downward on the leg strap ends according to the user's comfort level. The harness 12 engages with the upper frame via communication with the handrails (via the handrail caps 22). Said communication may be enabled with, for example, harness attachment-pins 18 (also visible in FIG. 1) inserted into the attachment-pin holes 20 (FIG. 1, shown on the left side only, but present on both sides). The upward force on the handrail caps 22 applies a lifting moment on the harness (FIG. 7) and user wearing the harness. As such, a lifting force is experienced by a user as he or she presses down on the handrails 16, as well as at both sides of the user's hip. While the placement of the harness at the hip is preferred, as it is most advantageous over previous walkers, it is recognized that the harness may attach just before or behind the hip, or have additional points of connection with the handrails. The harness itself may be made of a durable material, preferably a flexible reinforced material such as woven nylon or other durable polymer. The harness may also be made of plastic, metal, or other strong and rigid material capable of holding the weight of a human without undue wear and tear. The present inventor has recognized that previous devices with seats, such as U.S. Pat. No. 6,733,018, cited above, suffer from a disadvantage in that they intend to support a person's body weight by the seat. The present device, with its continuous lift on the handrails 16 reduces pressure that would otherwise be experienced at the user's crotch when using such devices. As a result the present device is not only more effective at reducing the weight felt by a person's lower body, but also is more comfortable.

Various modifications may be made to the disclosed apparatus without departing from the spirit of the invention. For instance, the lower frame may be a contiguous rigid member having different means for connecting the wheels 50. The device may be manufactured with or without the wheels. The width of the device may be modified so as to accommodate different sized individuals by lengthening or shortening the upper and lower crossbars. The gas springs may be equipped to provide varying levels of upward force. The entire device may be made collapsible. This may be accomplished by including lockable folding joints at various positions along the frame components (e.g., such as the middle of the handrails).

The foregoing has been a detailed description of two preferred embodiments of the device; however, various modifications and equivalents can be made without departing from the scope and spirit of the invention.

1. An apparatus comprising
an upper frame and a lower frame together connected by at least one lifting means, wherein
the lower frame comprises two sidebars connected at opposite ends of a lower crossbar to form a “U” shape; and
the upper frame comprises two handrails, each having a free end and an attachment end, wherein the attachment end of each handrail is rotatably connected to an upper crossbar; and
the lifting means are disposed between the lower crossbar and upper crossbar such that the upper frame experiences a force exerted by the lifting means when the handrails parallel to a plane formed by the lower frame.

2. The apparatus of claim 1 wherein the wherein the force exerted by the lifting means is a continuous lifting force.

3. The apparatus of claim 1, further comprising a harness for receiving a human lower torso wherein the harness is in removable communication with the two handrails.

4. The apparatus of claim 3, wherein the harness further comprises a harness belt adapted to encircle a user's waist, having disposed thereon means for connecting the harness belt to the handrail at a position corresponding to at least one side of a user's hip.

5. The apparatus of claim 3, wherein the force exerted by the lifting means is a continuous lifting force when the handrails are acted upon by a user applying weight on the handrails or the harness.

6. The apparatus of claim 1 further comprising a plurality of wheels supporting and engaging with the lower frame.

7. The apparatus of claim 1, configured such that it is collapsible.

8. The apparatus of claim 1, wherein the two handrails are in slidable communication with the upper crossbar.

9. The apparatus of claim 1, wherein the lifting means are a gas spring comprising at least a piston and ram, said gas spring in communication with a moment arm such that an end of the gas spring corresponding to the direction of the vertical force exerted by the gas spring is the end communicating with the moment arm; and wherein the moment arm is rotatably connected to the upper crossbar; and wherein the ram of the gas spring is in communication with the lower crossbar.

10. The apparatus of claim 9, wherein the moment arm is positioned between the two handrails.

11. A walker comprising
an upper frame and a lower frame together connected by at least one lifting means, wherein
the lower frame comprises two sidebars connected at opposite ends of a lower crossbar to form a “U” shape; and
the upper frame comprises two handrails, each having a free end and an attachment end, wherein the attachment end of each handrail is rotatably connected to an upper crossbar; and
the lifting means are disposed between the lower crossbar and upper crossbar such that the upper frame experiences a force exerted by the lifting means when the handrails parallel to a plane formed by the lower frame; and
a harness for receiving a human lower torso wherein the harness is in removable communication with the two handrails.

12. The walker of claim 10, wherein the harness further comprises a harness belt adapted to encircle a user's waist, having disposed thereon means for connecting the harness belt to the handrail at a position corresponding to at least one side of a user's hip.

13. The apparatus of claim 10, wherein the wherein the force exerted by the lifting means is a continuous lifting force.

14. The apparatus of claim 10, wherein the force exerted by the lifting means is a continuous lifting force when the handrails are acted upon by a user applying weight on the handrails or the harness.

15. The apparatus of claim 10, wherein the lifting means are a gas spring comprising at least a piston and ram, said gas spring in communication with a moment arm such that an end of the gas spring corresponding to the direction of the vertical force exerted by the gas spring is the end communicating with the moment arm; and wherein the moment arm is rotatably connected to the upper crossbar; and wherein the ram of the gas spring is in communication with the lower crossbar.

16. The apparatus of claim 1, further comprising a plurality of wheels supporting and engaging with the lower frame.

17. The apparatus of claim 1, configured such that it is collapsible.

18. The apparatus of claim 1, wherein the two handrails are in slidable communication with the upper crossbar.

19. The apparatus of claim 1, wherein the lifting means are positioned between the two handrails.
